(19) United States
(12) Patent Application Publication
(10) Pub. No.: US 2022/0275264 A1
(43) Pub. Date: Sep. 1, 2022

(54) FRICTION MATERIAL COMPOSITION, FRICTION MATERIAL, AND DISC BRAKE PAD

(71) Applicant: NISSHINBO BRAKE, INC., TOKYO (JP)

(72) Inventors: NAOYUKI YAMADA, GUNMA-KEN (JP); KAZUHIDE YAMAMOTO, GUNMA-KEN (JP); SHUHEI TAKESUE, GUNMA-KEN (JP)

(73) Assignee: NISSHINBO BRAKE, INC., TOKYO (JP)

(21) Appl. No.: 17/627,711

(22) PCT Filed: May 12, 2020
(86) PCT No.: PCT/JP2020/018977

§ 371 Date: Jan. 17, 2022

(30) Foreign Application Priority Data
Jul. 18, 2019 (JP) 2019-132923

(51) Int. Cl. C09K 3/14; C04B 35/634; C04B 35/63

(52) U.S. Cl. CPC C09K 3/149; C04B 35/63436; C04B 35/6303; C04B 2235/442; C04B 2235/963; C04B 2111/00362

(57) ABSTRACT

[Object] This invention, on an assumption that the environmental situation must be considered, reduces the brake noise, prevents the reduction of the braking effectiveness in the high temperature range, and improves the wear resistance.

[Means to Resolve] In the NAO friction material composition that does not practically contain a copper component, this invention contains the first substance made of such as the calcium carbonate that is the substance which becomes the sintered body during braking and is the precursor of the sintered body which keeps the powder generated from the disc rotor, and the second substance made of such as the fluoropolymer that is the sintering additive which aids sintering of the first substance.

[Selected Drawing(s)] None

### FIELD OF INVENTION

This invention relates to a friction material composition, a friction material, and a disc brake pad and particularly relates to a friction material composition, a friction material, and a disc brake pad for passenger vehicles such as automobiles, motorcycles, railway vehicles, and airplanes and for various type of industrial equipment or apparatus.

### FIELD OF INVENTION

A friction material used for a disc brake pad for automobiles that does not contain environmentally hazardous substances is on demand in order to eliminate an adverse effect on natural environment. Especially in recent years, a friction material that does not contain a copper component, which is a heavy metal, is in an international mainstream. A friction material, while no braking action is being performed after leaving and cooling the friction material for a while, often causes a noise of the brake so-called squeal noise generated due to vibration occurring while a braking action is being performed.

Patent Document 1 discloses the friction material composition that contains 0.5 mass % or less of the copper component within the friction material composition relative to the entire friction material composition and contains a fluoropolymer. This friction material does not practically contain the copper component but contains the fluoropolymer, and therefore is supposed to reduce the brake noise.

### PRIOR ART(S)

### Patent Document(s)

[Patent Document 1] Provisional Patent Publication No. 2015-93936

### SUMMARY OF INVENTION

### Problem to be Resolved by Invention

However, the friction material described in Patent Document 1 generates gas as the fluoropolymer, which is contained in the friction material, starting to be decomposed when the temperature of the friction material reaching a high temperature range of 390 centigrade or more due to the heat caused by braking actions. This decomposed gas can be a factor for reducing the braking effectiveness. Also, the strength of the friction material is reduced because of pores opened in the friction material when the fluoropolymer is decomposed, which causes abnormal wear of the friction material, thereby requiring a countermeasure.

This invention was developed in consideration of the above-identified problems and was aimed at least either to prevent the reduction of the braking effectiveness in the high temperature range or to improve the wear resistance on the assumption that the environmental situation is considered and the brake noise is reduced.

### Means to Resolve the Problems

In order to resolve the above-identified problems, this invention presents the NAO friction material composition containing a binder, a fiber base, an inorganic filler, and an organic filler that does not practically contain a copper component, and the NAO friction material composition includes a first substance that is a substance which becomes a sintered body during braking and is a precursor of the sintered body which keeps powder generated from a disc rotor, and a second substance that is an sintering additive which aids sintering of the first substance.

According to this invention, the following advantages can be achieved. Here, for the purpose of facilitating the understanding of this invention including the later explained embodiments and examples, as typical examples of this invention, the friction material is explained using the friction materials that are manufactured by using the friction material compositions employing the first substance made of the calcium carbonate as the inorganic filler and the second substance made of the fluoropolymer as the organic filler.

Normally, in order to secure the friction coefficient, the friction material contains the hard inorganic filler that can grind a surface of a disc rotor. Thus, the above-described inorganic filler is selected so that at least a part of the inorganic filler has a higher Mohs hardness than a surface material of the disc rotor so as to grind the surface of the disc rotor.

A disc rotor material of an automobile is selected from a cast iron, a cast steel, or a stainless steel. The cast iron that is often selected as the automobile disc rotor material is about 4.5 Mohs hardness, and therefore materials such as a zirconium silicate and a zirconium oxide that have Mohs hardness of 7.0 or more, which is much higher Mohs hardness than the cast iron, is often selected as the hard inorganic filler.

The disc rotor surface is grinded during braking by the hard inorganic filler, which has a higher Mohs hardness, contained in the friction material. Accordingly, cast iron powder is produced from the cast iron disc rotor as a result of grinding the surface thereof, and a part of the disc rotor powder is moved to adhere on the friction surface of the friction material.

Then, the temperature of the friction materiel during braking in some cases reaches to the high temperature range like 400 centigrade or more due to the friction heat caused between the friction material and the disc rotor. Because of the friction heat, the calcium carbonate contained in the friction material is sintered, and a sintered body results in firmly keeping the cast iron powder. At the same time, the fluoropolymer contained in the friction material as a sintering additive for the calcium carbonate.

As a result of each behavior described above, adhesive friction occurs between such as the cast iron powder firmly kept on the friction material surface and the disc rotor, thereby providing an advantage of improving the braking effectiveness. Also, the strength of the friction material is improved because of the sintered body of the calcium carbonate covering the friction material surface, thereby providing an advantage of improving the wear resistance.

These advantages cannot be obtained unless the amount of the fluoropolymer and the calcium carbonate contained in the friction material composition relative to the entire amount of the friction material composition is appropriate.

When the amount of the fluoropolymer contained in the friction material composition was less than 1 weight % relative to the entire amount of the friction material composition, the functionality of the calcium carbonate as the sintering additive was limited. Accordingly, the amount of production of the sintered body of the calcium carbonate became relatively small, and the braking effectiveness in the high temperature range and the wear resistance of the friction material were not sufficient.

On the other hand, when the amount of fluoropolymer contained in the friction material composition was over 5 weight % relative to the entire amount of the friction material composition, a lubricating effect in the fluoropolymer increased more than necessary. Therefore, it was understood that “braking effectiveness in a normal range of use” defined in the later-described embodiments decreased.

Thus, it was found that the amount of the fluoropolymer contained in the friction material composition relative to the entire amount of the friction material composition was preferably 1-5 weight %, and more preferably, in order to surely increase the effectiveness of this invention, the amount of the fluoropolymer relative to the entire amount of the friction material composition was 2-4 weight %.

The fluoropolymer may be such as a polytetrafluoroethylene (PTFE), a tetrafluoroethylene p-fluoroalkyl vinyl ether copolymer (PFA), and a tetrafluoroethylene hexafluoropropylene copolymer (FEP), and any one of the above-identified PTFE, PFA, or FEP or any combination of two or more of the above-identified PTFE, PFA, or FEP may be used.

Among these fluoropolymers, in view of the thermal resistance, the use of PTFE powder alone is preferable.

Also, when the amount of the calcium carbonate contained in the friction material composition relative to the entire amount of the friction material composition was less than 5 weight %, the amount of generated sintered body of the calcium carbonate became relatively small. Because of this reason, similar to the case when the amount of the fluoropolymer contained in the friction material composition was insufficient, the braking effectiveness and the wear resistance of the friction material in the high temperature range was insufficient.

Then, when the amount of the calcium carbonate contained in the friction material composition relative to the entire amount of the friction material composition was over 20 weight %, a mechanical strength of the friction material was limited. Therefore, it was found that the wear resistance of the friction material was reduced.

Accordingly, it was found that the amount of the calcium carbonate contained in the friction material composition relative to the entire amount of the friction material composition was preferably 5-20 weight %, and more preferably in order to surely increase the effectiveness of this invention, the calcium carbonate contained in the friction material composition relative to the entire amount of the friction material composition was 7-15 weight %.

Furthermore, the friction material of this invention may contain a lithium potassium titanate in the amount of 10-35 weight % relative to the entire amount of the friction material composition. Containing the lithium potassium titanate promoted a sintering effect of the calcium carbonate to make the above-explained advantages more obvious. In addition, so as to surely increase the advantage of this invention, the amount of lithium potassium titanate contained in the friction material composition is preferably 20-30 weight % relative to the entire amount of the friction material composition.

### EMBODIMENTS OF INVENTION

In the following sections, embodiments of the friction material composition, the friction material, and the disc brake pad in this invention are explained.

The friction material compositions in these embodiments have a basic structure of having the later explained binder, fiber base, inorganic filler, and organic filler.

(1) The binder mainly and mutually binds each raw material of the friction material such as the fiber base, the inorganic filler, and the organic filler, and additionally provides the predetermined strength to the friction material itself.

(2) The binder may be such as thermosetting resins of phenol resin system such as a straight phenol resin, a cashew oil modified phenol resin, an acrylic rubber modified phenol resin, a silicone rubber modified phenol resin, a nitrile rubber (NBR) modified phenol resin, a phenol aralkyl resin (aralkyl modified phenol resin), a fluoropolymer dispersed phenol resin, and a silicone rubber dispersed phenol resin, and any one of the above-identified thermosetting resins or any combination of two or more of the above-identified thermosetting resins may be used.

(3) The amount of the binder contained in the friction material composition relative to the entire amount of the friction material composition is preferably 8-13 weight % and is more preferably 9-12 weight %.

(1) The fiber base is added mainly to secure the strength and wear the resistance of the friction material.

(2) The fiber base may be organic fibers that are generally used for the friction material such as an aramid fiber, a cellulose fiber, a polyparaphenylene benzobisoxazole fiber, and an acrylic fiber, or metallic fibers that are generally used for the friction material such as an aluminum fiber, an aluminum alloy fiber, and a zinc fiber, and any one of the above-identified organic fibers or metallic fibers or any combination of two or more of the above-listed organic fibers or metallic fibers may be used.

(3) The amount of the fiber base contained in the friction material composition relative to the entire friction material composition is preferably 2-10 weight % and is more preferably 4-8 weight %.

(1) The inorganic filler is added mainly to improve the wear resistance, to adjust the friction coefficient, and to fix pH of the friction material.

(2) The inorganic filler, in addition to the above-described calcium carbonate and the lithium potassium titanate, may be:

(a) materials that are generally used for the friction material such as metal sulfide lubricants including zinc sulfide, molybdenum disulfide, tin sulfide, bismuth sulfide, tungsten sulfide, and composite metal sulfide, or carbon lubricants including artificial graphite, natural graphite, flake graphite, resilient graphitic carbon, petroleum coke, active carbon, and polyacrylonitrile oxide fiber pulverized powder,

(b) particle inorganic friction modifiers that are generally used for the friction material such as talk, clay, calcium hydroxide, barium sulfide, magnesia mica, potassium mica, vermiculite, triiron tetroxide, calcium silicate hydrate, glass bead, zeolite, mulite, chromite, titanium oxide, magnesium oxide, stabilized zirconia, monoclinic zirconium oxide, zirconium silicate, γ-alumina, α-alumina, silicon carbide, iron particles, zinc particles, tin particles, and non-whisker-like (plate-like, columnar, squamous, irregular/indefinite shape with multiple projections) titanate (potassium hexatitanate, potassium octatitanate, magnesium potassium titanate), and

(c) fiber inorganic friction modifiers that are generally used for the friction material such as wollastonite, sepiolite, basalt fiber, glass fiber, and rock wool, and any one of the above-identified materials, the particle inorganic friction modifiers, or the fiber inorganic modifiers, or any combination of two or more of the above-identified materials, the particle inorganic friction modifiers may be used.

(3) The amount of the inorganic filler, in addition to the above-described calcium carbonate and lithium potassium titanate, relative to the entire amount of the friction material composition, is preferably 50-85 weight % and is more preferably 60-80 weight %.

(1) The organic friction modifier is added for the purpose of adjusting the friction coefficient and improving the noise and vibration performance and wear resistance.

(2) The organic filler, other than the above-explained fluoropolymer, may be organic friction modifiers that are generally used for the friction material such as cashew dust, tire tread rubber pulverized powder, and vulcanized or unvulcanized rubber powder of nitrile rubber, acrylic rubber, silicon rubber, and butyl rubber, and any one of the above-identified organic friction modifiers or any combination of the above-identified organic friction modifier may be used.

(3) The amount of the organic filler, together with the above-identified fluoropolymer, relative to the entire friction material composition, is preferably 3-12 weight % and is more preferably 5-10 weight %.

The friction material of this embodiment is manufactured through:

(a) a mixing process for uniformly mixing the predetermined amount of the raw friction material using a mixer, (b) a heat pressure forming process for heat-press-forming the obtained raw friction material mixture after setting the obtained raw friction material mixture in a heat forming die,

(c) a heat treatment process for heating the obtained molded item to cause a chemical reaction of the binder therein to be cured, and

(d) a grinding process for grinding the friction material surface.

Prior to the heat-press-forming process, (a) a granulation process for granulating the raw friction material mixture or (b) a kneading process for kneading the raw friction material mixture, and (c) a preforming process for forming a preformed intermediate item after setting the raw friction material mixture, the granulated item obtained through the granulating process, or the kneaded item obtained through the kneading process in the preforming die, may be performed.

When manufacturing the disc brake pad, the raw friction material mixture and a back plate, which is prewashed, surface-treated, and adhesive coated thereon, are superposed to be set in a heat-forming die for heat-pressing the same through the heat-press-forming process.

In addition, (a) a coating process for coating a heat-treated product and (b) a baking process for baking the coated product may be added after the heat treatment process, and in addition, (c) a process for making a slit or/and a chamfer and (d) a scorching process may be added if necessary.

### EMBODIMENT

In the following section, each embodiment and comparative example of the friction material composition and the friction material that employs the friction material composition is explained concretely. Here, the friction material in each embodiment and comparative example is manufactured using the matching friction material composition in each embodiment and comparative example.

The manufacturing method for the friction material in each embodiment and comparative example is as follows.

[Manufacturing Method for Friction Material in Embodiments 1-14/Comparative Examples 1-4] The friction material compositions shown in Table 1 and Table 2 were mixed by Loedige mixer for about 5 minutes and were pressed in the forming die under 30 MPa for about 10 seconds, thereby conducing a pre-forming process to produce the preformed intermediate item. That intermediate item was superposed on a steel back plate, which was prewashed, surface-treated, and adhesive coated thereon, and was heat-formed in a heat forming die at the forming temperature of 150 centigrade under the forming pressure of 40 MPa for about 10 minutes. Then, the heat-formed intermediate item was heat-treated (cured) at 200 centigrade for about 5 hours, and the obtained item through the above-processes was grinded to form a friction surface to complete a disc brake pad for an automobile (Embodiments 1-14, Comparative Examples 1-4).

In the respective friction material composition of the embodiments, containing the appropriate amount of the calcium carbonate and the fluoropolymer is important. To measure and determine the appropriate amount, for example, setting a center weight % of the calcium carbonate as 12 weight % and setting a center weight % of the fluoropolymer as 3 weight %, the amount of calcium carbonate and the amount of fluoropolymer were increased or decreased to evaluate the various appropriate amounts.

TABLE 1

| | | Embodiments | | | | | | | | |
|---|---|---|---|---|---|---|---|---|---|---|
| | | 1 | 2 | 3 | 4 | 5 | 6 | 7 | 8 | 9 |
| binder | phenol resin | 10 | 10 | 10 | 10 | 10 | 10 | 10 | 10 | 10 |
| fiber base | aramid fiber | 6 | 6 | 6 | 6 | 6 | 6 | 6 | 6 | 6 |
| inorganic filler | graphite | 2 | 2 | 2 | 2 | 2 | 2 | 2 | 2 | 2 |
| | molybdenum disulfide | 3 | 3 | 3 | 3 | 3 | 3 | 3 | 3 | 3 |
| | zirconium oxide | 10 | 10 | 10 | 10 | 10 | 10 | 10 | 10 | 10 |
| | zirconium silicate | 1 | 1 | 1 | 1 | 1 | 1 | 1 | 1 | 1 |
| | calcium hydroxide | 3 | 3 | 3 | 3 | 3 | 3 | 3 | 3 | 3 |
| | barium sulfide | 22 | 21 | 20 | 19 | 18 | 27 | 25 | 17 | 12 |
| | calcium carbonate | 12 | 12 | 12 | 12 | 12 | 5 | 7 | 15 | 20 |
| | lithium potassium | 25 | 25 | 25 | 25 | 25 | 25 | 25 | 25 | 25 |
| | titanate | | | | | | | | | |
| | potassium hexatitanate | 0 | 0 | 0 | 0 | 0 | 0 | 0 | 0 | 0 |
| organic filler | fluorine based polymer | 1 | 2 | 3 | 4 | 5 | 3 | 3 | 3 | 3 |
| | cashew dust | 3 | 3 | 3 | 3 | 3 | 3 | 3 | 3 | 3 |
| | tire tread rubber | 2 | 2 | 2 | 2 | 2 | 2 | 2 | 2 | 2 |
| | pulverized powder | | | | | | | | | |
| Total (weight %) | | 100 | 100 | 100 | 100 | 100 | 100 | 100 | 100 | 100 |
| | | | | | | | Comparative | | | |
| | | Embodiments | | | | | Examples | | | |
| | | 10 | 11 | 12 | 13 | 14 | 1 | 2 | 3 | 4 |
| binder | phenol resin | 10 | 10 | 10 | 10 | 10 | 10 | 10 | 10 | 10 |
| fiber base | aramid fiber | 6 | 6 | 6 | 6 | 6 | 6 | 6 | 6 | 6 |
| inorganic filler | graphite | 2 | 2 | 2 | 2 | 2 | 2 | 2 | 2 | 2 |
| | molybdenum disulfide | 3 | 3 | 3 | 3 | 3 | 3 | 3 | 3 | 3 |
| | zirconium oxide | 10 | 10 | 10 | 10 | 10 | 10 | 10 | 10 | 10 |
| | zirconium silicate | 1 | 1 | 1 | 1 | 1 | 1 | 1 | 1 | 1 |
| | calcium hydroxide | 3 | 3 | 3 | 3 | 3 | 3 | 3 | 3 | 3 |
| | barium sulfide | 20 | 20 | 10 | 9 | 20 | 22.5 | 17 | 28 | 11 |
| | calcium carbonate | 12 | 12 | 12 | 12 | 12 | 12 | 12 | 4 | 21 |
| | lithium potassium | 9 | 10 | 35 | 36 | 0 | 25 | 25 | 25 | 25 |
| | titanate | | | | | | | | | |
| | potassium hexatitanate | 16 | 15 | 0 | 0 | 25 | 0 | 0 | 0 | 0 |
| organic filler | fluorine based polymer | 3 | 3 | 3 | 3 | 3 | 0.5 | 6 | 3 | 3 |
| | cashew dust | 3 | 3 | 3 | 3 | 3 | 3 | 3 | 3 | 3 |
| | tire tread rubber | 2 | 2 | 2 | 2 | 2 | 2 | 2 | 2 | 2 |
| | pulverized powder | | | | | | | | | |

| | | | | | | | | | |
|---|---|---|---|---|---|---|---|---|---|
| Total (weight %) | 100 | 100 | 100 | 100 | 100 | 100 | 100 | 100 | 100 |

Table 1 shows the amount of the respective material contained in the friction material compositions in Embodiments 1-14 and Comparative Examples 1-4.

Firstly, the respective friction material compositions in the embodiments and the comparative examples commonly contains the phenol resin as the binder, and also about 10 weight % of the phenol resin relative to the entire amount of the friction material composition is commonly contained therein.

Secondly, the respective friction material compositions in the embodiments and comparative examples commonly contains the aramid fiber as the fiber base, and also about 6 weight % of the aramid fiber relative to the entire amount of the friction material composition is commonly contained therein.

Thirdly, the respective friction material composition in the embodiments and comparative examples commonly contains the graphite, the molybdenum disulfide, the zirconium oxide, the zirconium silicate, and the calcium hydroxide as the inorganic filler, and also about 2 weight % of the graphite, 3 weight % of the molybdenum disulfide, 10 weight % of the zirconium oxide, 1 weight % of the zirconium silicate, and 3 weight % of the calcium hydroxide are commonly contained therein relative to the entire amount of the friction material composition.

Fourthly, although the respective friction material composition in the embodiments and comparative examples commonly contains the barium sulfide and the calcium carbonate as the inorganic filler, differences exist in the amounts of the barium sulfide and the calcium carbonate, which are treated as variables. Also, differences exist in some of the friction material compositions in the embodiments and comparative examples which selectively contain the lithium potassium titanate, and the potassium hexatitanate therein.

Fifthly, the respective friction material composition of the embodiments and the comparative examples commonly contains the cashew dust and the tire tread rubber pulverized powder as the organic filler, and moreover the amount of the cashew dust contained therein is commonly about 3 weight % and the amount of the tire tread rubber pulverized powder is commonly about 2 weight % relative to the entire friction material composition.

Sixthly, the respective friction material composition of the embodiments and the comparative examples commonly contains the fluoropolymer as the organic filler therein; however, the amounts of the fluoropolymer are different, which are regarded as valuables.

In Embodiments 1-5, the amounts of the barium sulfide and the fluoropolymer contained in the friction material composition are different; however, the amounts of other materials including the calcium carbonate contained therein are same. From Embodiment 1 to Embodiment 5, the amount of the barium sulfide was reduced by 1 weight % at every embodiment from Embodiment 1 to Embodiment 5 respectively in order while the amount of fluoropolymer was increased by 1 weight % at every embodiment from Embodiment 1 to Embodiment 5 respectively in order.

Embodiments 6-9 contain different amounts of the barium sulfide and the calcium carbonate but the amounts of other materials including the fluoropolymer contained therein are same. From Embodiments 6 to Embodiment 9, the amount of the barium sulfide was reduced by 1 weight % at every embodiment from Embodiment 6 to Embodiment 9 respectively in order while amount of calcium carbonate was increased by 1 weight % at every embodiment from Embodiment 6 to Embodiment 9 respectively in order.

Embodiments 10-14 contains the different amounts of the barium sulfide, the lithium potassium titanate, and the potassium hexatitanate; however, Embodiments 10-14 contain the same amounts of other materials including the calcium carbonate and the fluoropolymer. The amounts of the barium sulfide, the lithium potassium titanate, and the potassium hexatitanate were changed without regularity.

Comparative Examples 1-4 contain the different amount of the barium sulfide, the calcium carbonate, and the fluoropolymer. Here, Comparative Examples 1-4 contain the same amount of other materials. The friction materials in Comparative Examples 1 and 2 are compared with the embodiments in Embodiments 1-5. The friction materials in Comparative Embodiments 3 and 4 are compared with the friction materials in Embodiments 6-9.

TABLE 2

| | | | | | | | | | | | | | | | | Comparative | | | |
|---|---|---|---|---|---|---|---|---|---|---|---|---|---|---|---|---|---|---|---|
| | | Embodiments | | | | | | | | | | | | | | Examples | | | |
| | | 1 | 2 | 3 | 4 | 5 | 6 | 7 | 8 | 9 | 10 | 11 | 12 | 13 | 14 | 1 | 2 | 3 | 4 |
| Evaluation | braking effectiveness | E | E | E | G | P | E | E | E | E | E | E | E | E | E | E | F | E | E |
| Result | of the normal range of use | | | | | | | | | | | | | | | | | | |
| | braking effectiveness | P | G | E | E | G | P | G | E | G | G | E | E | E | G | F | P | F | P |
| | in high speed high | | | | | | | | | | | | | | | | | | |
| | load condition | | | | | | | | | | | | | | | | | | |
| | wear resistance of | P | G | E | E | E | P | G | G | P | G | E | E | G | G | F | E | F | F |
| | the friction material | | | | | | | | | | | | | | | | | | |

E = Excellent
G = Good
P = Pass
F = Fail

Table 2 shows an evaluation result of the friction materials manufactured by using the friction material compositions in Embodiments 1-14 and Comparative Examples 1-4. Here, Table 2 shows the evaluation result of each and following definitions, i.e., (1) “the braking effectiveness in the normal range of use”, (2) “the braking effectiveness in high speed high load condition”, and (3) “the wear resistance of the friction material”. In addition, these evaluation results are based on the testing of the friction material of the respective embodiment and comparative example used in a rear disc brake.

For evaluating (1) “the braking effectiveness of the normal range of use”, the second effectiveness test was conducted based on JASO C406, “Passenger Car—Braking Device—Dynamometer Test Procedures”. Here, the brake was applied to the disc rotors which were rotating at 50 km/h under the fluid pressure of about 4 MPa until the rotation speed reached 0 km/h.

The respective evaluation result shown in the row of (1) “the braking effectiveness of the normal range of use” of Table 2 is based on an average friction coefficient μ after 5 brake actions, and Excellent, Good, Pass, and Fail can be defined as follows:

Excellent: 0.42 or more but less than 0.46;

Good: 0.38 or more but less than 0.42;

Pass: 0.34 or more but less than 0.38; and

Fail: less than 0.34.

When evaluating (2) “the braking effectiveness in high speed high load condition”, and (3) “the wear resistance of the friction material”, High Speed Pattern Simulation Test published in German Car Magazine, “Auto Motor Und Sport” (AMS) was performed under 150% condition by speed. Here, one brake action with the deceleration speed of 0.6 g was performed until the disc rotors rotating at 240 km/h reached the rotation speed of 5 km/h.

The respective evaluation result shown in the row of (2) “the braking effectiveness in high speed high load condition” of Table 2 is the respective evaluation result of the minimum value of an average friction coefficient μ at the final brake action, and Excellent, Good, Pass, and Fail can be defined as follows:

Excellent: 0.20 or more:

Good: 0.15 or more but less than 0.20;

Pass: 0.10 or more but less than 0.15; and

Fail: less than 0.10.

The respective evaluation result shown in the row of (3) “the wear resistance of the friction material” of Table 2 is judged based on the amount of the friction material wear after the High Speed Pattern Simulation Test, and Excellent, Good, Pass, and Fail can be defined as follows:

Excellent: less than 2.0 mm;

Good: 2.0 mm or more but less than 3.00 mm;

Pass: 3.0 mm or more but less than 4.00 mm; and

Fail: 4.0 mm or more.

Firstly, in view of the evaluation results of (1) “the braking effectiveness of the normal range of use” in the friction materials of Embodiments 1-5, all friction materials in Embodiments 1-3 are Excellent; the friction material in Embodiment 4 is Good result; and the friction material in Embodiment 5 is Pass result. Accordingly, so far as (1) “the braking effectiveness of the normal range of use” is concerned, it can be said that the evaluation is low when the amount of the fluoropolymer is large.

Secondly, in view of the evaluation result of (2) “the braking effectiveness in high speed high load condition” in the friction materials of Embodiments 1-5, the evaluation results for all friction materials in Embodiments 3 and 4 are Excellent; the evaluation results for all friction materials in Embodiments 2 and 5 are Good; and the evaluation results for the friction material in Embodiment 1 is Pass. Therefore, with respect to the evaluation result of (2) “the braking effectiveness in high speed high load condition”, it can be said that there is an adverse effect on the evaluation results when the amount of the fluoropolymer is small.

Thirdly, in view of the evaluation result of (3) “the wear resistance of the friction material” in the friction materials of Embodiments 1-5, the evaluation result for the friction material in Embodiment 1 is Pass; the evaluation result for the friction material in Embodiment 2 is Good; and the evaluation results for the friction materials in Embodiments 3-5 are Excellent. Accordingly, with respect to (3) “the wear resistance of the friction material”, it can be said that the evaluation is low when the amount of the fluoropolymer is small.

Referring to Comparative Example 1, the friction material in Comparative Example 1 shows 0.5 weight % less fluoropolymer contained therein than that of Embodiment 1. In this case, the evaluation results of both (2) “the braking effectiveness in high speed high load condition” and (3) “the wear resistance of the friction material” were Fail.

Then, referring to Comparative Example 2, the friction material in Comparative Example 2 shows 1 weight % more fluoropolymer contained therein than that of Embodiment 5. In this case, the evaluation result of (1) “the braking effectiveness of the normal range of use” was Fail.

In consideration of the above-evaluation results, it was found that the evaluation results for the friction materials in Embodiments 1-5, when the amounts of the fluoropolymer contained therein is appropriate, were Excellent with respect to all (1) “the braking effectiveness of the normal range of use”, (2) “the braking effectiveness in high speed high load condition”, and (3) “the wear resistance of the friction material”.

Furthermore, in consideration of the evaluation results of the friction materials in Comparative Examples 1 and 2, it was found that the evaluation results of the friction materials in Embodiments 1-5 all pass and satisfy the evaluation criteria when the amount of the fluoropolymer is 1 weight % or more but 5 weight % or less relative to the entire friction material composition. Especially, just like Embodiments 2-4, it can be said that the evaluation results of the friction material are Good when the amount of the fluoropolymer is 2-4 weight % relative to the entire friction material composition.

Then, referring to the evaluation results of (1) “the braking effectiveness of the normal range of use” with respect to Embodiments 6-9, all evaluation results of the friction materials in Embodiments 6-9 were Excellent.

Then, referring to (2) “the braking effectiveness in high speed high load condition” with respect to the friction materials in Embodiments 6-9, the evaluation result for the friction material in Embodiment 8 was Excellent; the evaluation results for the friction materials in Embodiments 7 and 9 were Good; and the evaluation result for the friction material in Embodiment 6 was Pass. Accordingly, it can be said that the evaluation result for (2) “the braking effectiveness in high speed high load condition” is not preferable when the amount of the calcium carbonate is small.

Then, referring to the evaluation results for (3) “the wear resistance of the friction material” with respect to Embodiments 6-9, the evaluation result for the friction materials in Embodiments 7 and 8 were Good and the evaluation results for the friction material in Embodiments 6 and 9 were Pass. Accordingly, it can be said that the evaluation result for (3) “the wear resistance of the friction material” is not preferable when the amount of the calcium carbonate is large or small.

Referring to Comparative Example 3, the friction material in Comparative Example 3 shows 1 weight % less calcium carbonate than Embodiment 6 relative to the entire amount of the friction material composition. In this case, the evaluation results for (2) “the braking effectiveness in high speed high load condition” and (3) “the wear resistance of the friction material” were Fail.

Then, referring to Comparative Example 4, the friction material in Comparative Example 4 shows 1 weight % more calcium carbonate contained therein than that of the friction material in Embodiment 9. In this case, the evaluation result for (3) “the wear resistance of the friction material” was Fail.

In consideration of the above-evaluation results, it can be said that the evaluation results for the friction materials in Embodiments 6-9, when the amounts of the calcium carbonate contained therein was appropriate, all passed and satisfied the evaluation criteria with respect to all (1) “the braking effectiveness of the normal range of use”, (2) “the braking effectiveness in high speed high load condition”, and (3) “the wear resistance of the friction material”.

Furthermore, in consideration of the evaluation results for the friction materials in Comparative Examples 3 and 4, it was found that the amount of the calcium carbonate in the friction materials in Embodiments 6-9 were preferably 5 weight % or more but 20 weight % or less. Especially, just like Embodiments 7 and 8, it can be said that the amount of calcium carbonate relative to the entire amount of friction material composition is preferably 7-8 weight %.

Then, referring to the evaluation results of (1) “the braking effectiveness of the normal range of use” with respect to Embodiments 10-14, all evaluation results with respect to Embodiments 10-14 were Excellent.

Furthermore, referring to the evaluation results for the friction materials of (2) “the braking effectiveness in high speed high load condition”, all evaluation results for Embodiments 11-13 were Excellent and all evaluation results for Embodiments 10 and 14 were Good.

Here, as examining in more detail of the evaluation results, with respect to Embodiments 10 and 11 and 14, the amount of the lithium potassium titanate and potassium hexatitanate same but the content ratio thereof are different.

More concretely, to focus on the lithium potassium titanate, the amount of the same in Embodiment 10 was 10 weight % relative to the entire friction material composition, and the amount of the same in Embodiment 11 was 9 weight % relative to the entire friction material composition. Regardless of the above-evaluation results, the evaluation result for (2) “the braking effectiveness in high speed high load condition” with respect to Embodiment 10 was Good and that with respect to 11 was Excellent.

Then, with respect to Embodiments 1-9, preferable evaluation results can be seen for (2) “the braking effectiveness in high speed high load condition” even without containing the potassium hexatitanate, and with respect to Embodiment 14, the evaluation result for the friction material was Good with relatively large amount of the potassium hexatitanate, and therefore, it can be understood that an existence of the potassium hexatitanate does not make a significant effect on the evaluation result for (2) “the braking effectiveness in high speed high load condition”.

Accordingly, it can be understood that the amount of the lithium potassium titanate affects on the evaluation result for the friction material for (2) “the braking effectiveness in high speed high load condition” and that the amount of the lithium potassium titanate contained therein is preferably 10 weight % or more relative to the entire amount of the friction material composition.

Then, referring to the evaluation results for (3) “the wear resistance of the friction material” with respect to Embodiments 10-14, all evaluation results for the friction materials in Embodiments 11 and 12 were Excellent and all evaluation results for the friction materials in Embodiments 13 and 14 were Good.

Here, as examining in more detail of the evaluation results, with respect to Embodiments 12 and 13, both embodiments do not contain the potassium hexatitanate and the amounts of the lithium potassium titanate are slightly different only.

More concretely, to focus on the lithium potassium titanate, the amount of the same in Embodiment 12 was 35 weight % relative to the entire friction material composition, and the amount of the same in Embodiment 13 was 36 weight % relative to the entire friction material composition. Regardless of the above-evaluation results, the evaluation result for (3) “the wear resistance of the friction material” with respect to Embodiment 12 was Excellent and that with respect to 13 was Good.

Furthermore, with respect to Embodiments 1-9, because the preferable evaluation result was obtained for (3) “the wear resistance of the friction material” even without containing the potassium hexatitanate, it can be said that the amount of the lithium potassium titanate contained therein is preferably 35 weight % or lower relative to the entire friction material composition.

In consideration of the above-evaluation results, the friction materials in Embodiments 10-14, assuming that the amount of the calcium carbonate is predetermined (as desired), the amount of the lithium potassium titanate relative to the entire friction material composition is preferably 36 weight % or less.

Especially, as in Embodiments 11 and 12, it can be said that the amount of the lithium potassium titanate contained therein relative to the entire amount of the friction material composition is preferably 10-35 weight %.

1. A non-asbestos-organic (NAO) friction material composition, containing a binder, a fiber base, an inorganic filler, and an organic filler that does not practically contains a copper component, wherein
said NAO friction material composition includes
(1) a first substance that is a substance which becomes a sintered body during braking and is a precursor of said sintered body which keeps powder generated from a disc rotor, and
(2) a second substance that is a sintering additive which aids sintering of the first substance.

2. The NAO friction material composition of claim 1, wherein
said first substance is a calcium carbonate as an inorganic filler, and 5-20 weight % of said calcium carbonate, relative to the entire amount of the friction material composition, is contained in the friction material composition, and
said second substance is a fluoropolymer as an organic filler, and 1-5 weight % of said fluoropolymer, relative to the entire amount of the friction material composition, is contained in the friction material composition.

3. The NAO friction material composition of claim 1, wherein
10-35 weight % a lithium potassium titanate, relative to the entire amount of the friction material composition, is contained in the friction material composition.

4. The NAO friction material composition of claim 2, wherein
10-35 weight % a lithium potassium titanate, relative to the entire amount of the friction material composition, is contained in the friction material composition.

5. A friction material manufactured using the NAO friction material composition according to claim 1.

6. The friction material manufactured using the NAO friction material composition according to claim 2.

7. The friction material manufactured using the NAO friction material composition according to claim 3.

8. The friction material manufactured using the NAO friction material composition according to claim.

9. A disc brake pad mounting the friction material on a back plate according to claim 5.

10. A disc brake pad mounting the friction material on a back plate according to claim 6.

11. A disc brake pad mounting the friction material on a back plate according to claim 7.

12. A disc brake pad mounting the friction material on a back plate according to claim 8.
